(19) United States
(12) Patent Application Publication
(10) Pub. No.: US 2023/0127993 A1
(43) Pub. Date: Apr. 27, 2023

(54) LOCKING MECHANISM AND ELECTRONIC APPARATUS

(71) Applicant: Wistron Corp., New Taipei City (TW)

(72) Inventors: Bo-Chun Lin, New Taipei City (TW); Fu-Chieh Hsu, New Taipei City (TW)

(21) Appl. No.: 17/540,126

(22) Filed: Dec. 1, 2021

(30) Foreign Application Priority Data
Oct. 25, 2021 (TW) 110139440

(51) Int. Cl. E05C 9/02; E05B 47/00

(52) U.S. Cl. CPC E05C 9/021; E05B 47/0012; E05B 2047/002

(57) ABSTRACT

A locking mechanism is provided. The locking mechanism includes a base, a connecting rod, a fastener, and a linking member. The connecting rod and the fastener penetrate the base and are rotatable relative to the base. The connecting rod and the fastener are disposed parallel to each other. The linking member is connected to the connecting rod and the fastener, and is configured to link up the connecting rod and the fastener. Accordingly, the locking mechanism may be suitable for an expansion device with a specific size, and therefore the performance and the design flexibility of the electronic apparatus may be enhanced.

### CROSS REFERENCE TO RELATED APPLICATIONS

This Application claims priority of Taiwan Patent Application No. 110139440, filed on Oct. 25, 2021, the entirety of which is incorporated by reference herein.

### BACKGROUND

### Technical Field

The disclosure relates to a locking mechanism and electronic apparatus, and in particular to a locking mechanism and electronic apparatus including a linking member for linking the connecting rod to the fastener.

### Description of the Related Art

With the development of technology, the application of electronic devices is also becoming more and more popular. In particular, users have higher demands on the performance of electronic devices. Therefore, there are many expansion devices and electronic components that match the electronic devices on the market, as well as the lock mechanisms that are suitable for fixing the aforementioned expansion devices. However, the existing lock mechanisms are not satisfactory in all respects, and there is still room for improvement.

### BRIEF SUMMARY

The present disclosure provides a locking mechanism. The locking mechanism includes a base, a connecting rod, a fastener and a linking member. The connecting rod penetrates the base and is rotatable relative to the base. The fastener penetrates the base and is rotatable relative to the base, wherein the connecting rod is disposed parallel to the fastener. The linking member is connected to, and configured to link up with, the connecting rod and the fastener.

The present disclosure provides an electronic apparatus. The electronic apparatus includes a bottom plate, an expansion device disposed on the bottom plate and a locking mechanism. The locking mechanism is configured to affix the expansion device onto the bottom plate, and includes: a base, a connecting rod, a fastener and a linking member. The connecting rod penetrates the base and is rotatable relative to the base. The fastener penetrates the base and is rotatable relative to the base, wherein the connecting rod is disposed parallel to the fastener. The linking member is connected to, and configured to link up with, the connecting rod and the fastener.

### BRIEF DESCRIPTION OF THE DRAWINGS

The disclosure may be more fully understood by reading the subsequent detailed description and examples with references made to the accompanying drawings, wherein:

FIG. 1 illustrates a perspective view of an electronic apparatus in accordance with some embodiments of the present disclosure.

FIG. 2 illustrates an enlarged perspective view of an expansion device and a locking mechanism in accordance with some embodiments of the present disclosure.

FIG. 3 illustrates an exploded view of the locking mechanism in accordance with some embodiments of the present disclosure.

FIG. 4 illustrates a cross-sectional view of the locking mechanism and the bottom plate along the line A-A shown in FIG. 1 in accordance with some embodiments of the present disclosure.

FIG. 5 illustrates a cross-sectional view of the locking mechanism and the bottom plate along the line A-A shown in FIG. 1 in accordance with some embodiments of the present disclosure.

FIG. 6 illustrates a cross-sectional view of the locking mechanism and the bottom plate along the line A-A shown in FIG. 1 in accordance with some embodiments of the present disclosure.

FIG. 7 illustrates a perspective view of the locking mechanism in accordance with some embodiments of the present disclosure.

FIG. 8 illustrates a partial enlarged perspective view of the locking mechanism in accordance with some embodiments of the present disclosure.

### DETAILED DESCRIPTION OF THE INVENTION

The locking mechanism and electronic apparatus of some embodiments of the present disclosure are described in the following description. However, it should be appreciated that the following detailed description of some embodiments of the disclosure provides various concepts of the present disclosure which may be performed in specific backgrounds that may vary widely. The specific embodiments disclosed are provided merely to clearly describe the usage of the present disclosure by some specific methods without limiting the scope of the present disclosure.

In addition, relative terms such as “lower” or “bottom,” “upper” or “top” may be used in the following embodiments in order to describe the relationship between one element and another element in the figures. It should be appreciated that if the device shown in the figures is flipped upside-down, the element located on the “lower” side may become the element located on the “upper” side.

It should be understood that although the terms “first,” “second,” etc. may be used herein to describe various elements, materials and/or portions, these elements, materials and/or portions are not limited by the above terms. These terms merely serve to distinguish different elements, materials and/or portions. Therefore, a first element, material and/or portion may be referred to as a second element, material and/or portion without departing from the teaching of some embodiments in the present disclosure. Unless defined otherwise, the first or second element, material and/or portion in the claims may be interpreted as any element, material and/or portion in the specification as long as it conforms to the description in the claims.

Unless defined otherwise, all terms (including technical and scientific terms) used herein have the same meaning as commonly understood by one of ordinary skill in the art to which the present disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure. In addition, the terms “substantially,” “approximately” or “about” may also be recited in the present disclosure, and these terms are intended to encompass situations or ranges that is substantially or exact the same as the description herein. It should be noted that unless defined specifically, even if the above terms are not recited in the description, it should be read as the same meaning as those approximate terms are recited.

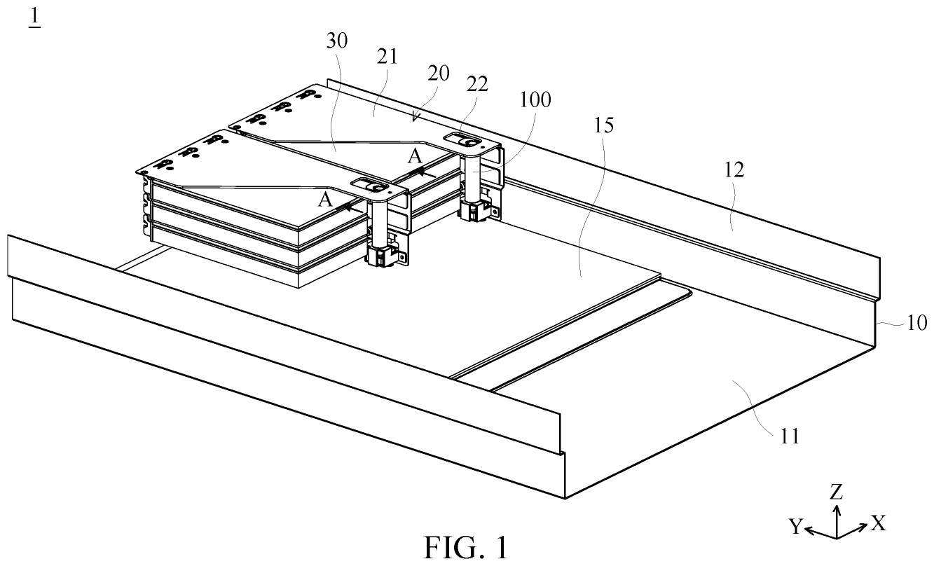

FIG. 1 illustrates a perspective view of an electronic apparatus 1 in accordance with some embodiments of the present disclosure. As shown in FIG. 1, the electronic apparatus 1 may include a bottom plate 10, an expansion device 20, an electronic component 30 and a locking mechanism 100. In some embodiments, the electronic apparatus 1 may be a computer case, a server case, etc., and may be applied to an electronic computer or any suitable device, but the present disclosure is not limited thereto. In some embodiments, the bottom plate 10 may have a bottom surface 11 and opposite sidewalls 12 that extend from the bottom surface 11. As shown in FIG. 1, the bottom surface 11 may be substantially parallel to a horizontal plane (for example, the X-Y plane), and the sidewalls 12 may be substantially parallel to a vertical surface (for example, the Y-Z plane), but the present disclosure is not limited thereto. In some embodiments, a circuit board 15 may be disposed on the bottom plate 10. For example, the circuit board 15 may be a printed circuit board (PCB) or other suitable components.

The expansion device 20 may be, for example, a riser card or the like, and may be electrically connected to the circuit board 15. At least one electronic component 30 may be connected to the expansion device 20. For example, the electronic component 30 may adopt a bus such as PCI Express (PCIe), but the present disclosure is not limited thereto. The locking mechanism 100 may be configured to affix the expansion device 20 onto the bottom plate 10. The structure and operation of the locking mechanism 100 will be further described below. In some embodiments, the expansion device 20 has a top surface 21 and an opening 22 formed on the top surface 21. The top surface 21 may be located above the electronic component 30 and at least partially cover the electronic component 30 to protect the electronic component 30. The opening 22 may be a substantially rectangular opening, and may expose a part of the locking mechanism 100 in a top view (i.e., on the X-Y plane), so as to facilitate the operation of the locking mechanism 100. In the present embodiment, the locking mechanism 100 may not protrude from the opening 22 (that is, the position of the locking mechanism 100 is lower than the top surface 21), thereby reducing the probability that the locking mechanism 100 interferes with the expansion device 20.

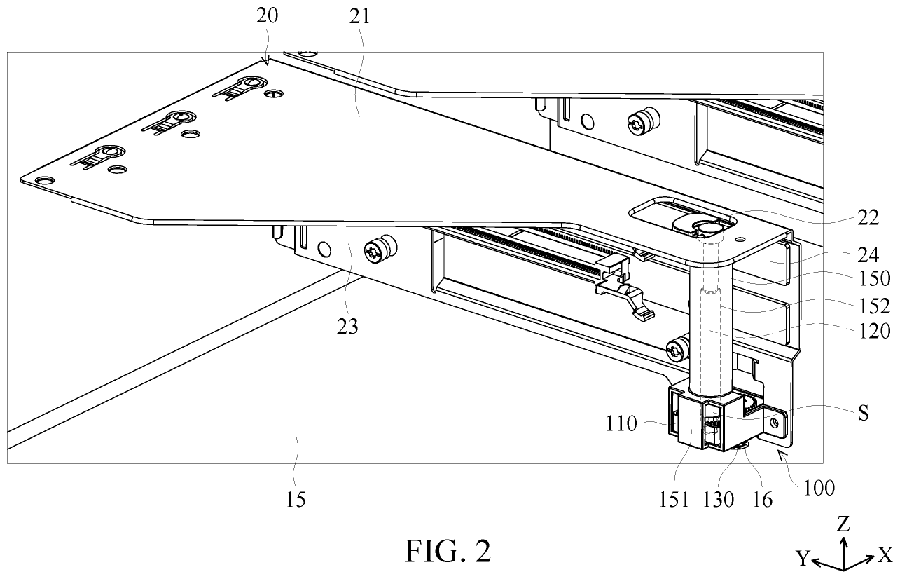

FIG. 2 illustrates an enlarged perspective view of the expansion device 20 and the locking mechanism 100 in accordance with some embodiments of the present disclosure. As shown in FIG. 2, the expansion device 20 has a side surface 23 that is substantially perpendicular to the top surface 21 and a plurality of slots 24 disposed on the side surface 23. In some embodiments, the slots 24 may be each used to accommodate the electronic components 30. In some embodiments, electrical signals may be transmitted via the slots 24 and the electronic components 30. In this way, the performance of the electronic apparatus 1 may be enhanced. Since the locking mechanism 100 affixes the expansion device 20, the reliability of the electronic apparatus 1 may be improved.

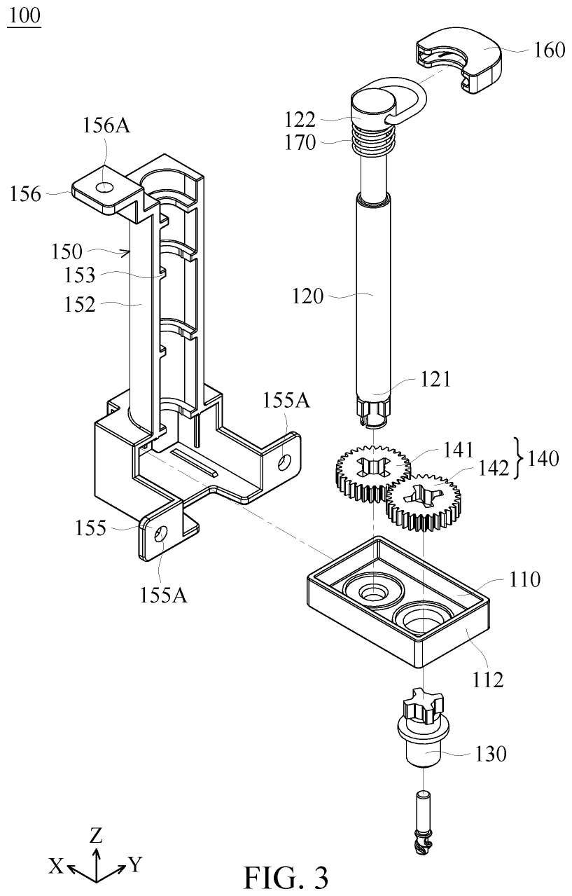

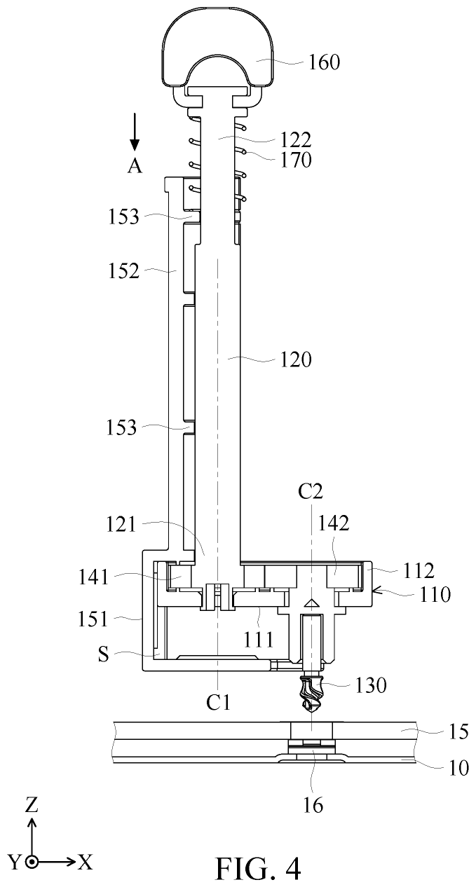

In addition, the locking mechanism 100 includes a base 110, a connecting rod 120, and a fastener 130. The base 110 may have a substantially rectangular structure. The connecting rod 120 may extend through the base 110 and be rotatable relative to the base 110. The fastener 130 may also extend through the base 110 and be rotatable relative to the base 110. More specifically, the connecting rod 120 and the fastener 130 may be arranged substantially parallel to each other, and respectively protrude from the base 110 from opposite sides of the base 110. For example, the connecting rod 120 protrudes from the base 110 toward the top surface 21, and the fastener 130 may protrude from the base 110 toward the circuit board 15. However, the present disclosure is not limited thereto. Those skilled in the art may adjust the configuration of the connecting rod 120 and the fastener 130 based on the content of the present disclosure, and will not be discussed in detail below. For example, the fastener 130 may be a screw, which is suitable for being fixed in the hole 16 in the circuit board 15. The fastener 130 and the hole 16 may have corresponding threads, and the fastener 130 may be fixed in the hole 16 by rotating the fastener 130 in the hole 16. However, the present disclosure is not limited thereto. Any component is acceptable as long as the fastener 130 may be affixed to the hole 16. The connecting rod 120 may drive the fastener 130 to rotate via a linking member (for example, referring to FIG. 3). The operation mode of the locking mechanism 100 will be described in more detail in conjunction with FIGS. 4-6.

In some embodiments, the locking mechanism 100 further includes a frame 150 disposed around the base 110 and the connecting rod 120, so as to protect the internal components of the locking mechanism 100. More specifically, in the present embodiment, the frame 150 has a plurality of side sections 151 and an annular sidewall 152 that are connected to each other. The base 110 may be accommodated in a space S that is surrounded by the side sections 151, and the connecting rod 120 may be located in the annular sidewall 152. In addition, the frame 150 may also be affixed to the expansion device 20 via a fastener (not shown), so that the expansion device 20 may be affixed by the locking mechanism 100. For example, screws may be disposed to penetrate the frame 150 and the expansion device 20, but the present disclosure is not limited thereto.

FIG. 3 illustrates an exploded view of the locking mechanism 100 in accordance with some embodiments of the present disclosure. As shown in FIG. 3, the locking mechanism 100 includes a linking member 140, which is suitable for linking up (for example, synchronously rotating) the connecting rod 120 and the fastener 130. In some embodiments, the linking member 140 includes a first gear 141 and a second gear 142 that are engaged with each other, and are accommodated in a space surrounded by the sidewalls 112 of the base 110. The first gear 141 may be disposed around the connecting rod 120, and the second gear 142 may be disposed around the fastener 130. In some embodiments, the first gear 141 and the connecting rod 120 may be combined in a corresponding style (for example, having a corresponding shape). Similarly, the second gear 142 and the fastener 130 may also be combined in a corresponding style. However, the present disclosure is not limited thereto. With the above configuration, by the rotation of the connecting rod 120, the fastener 130 may be driven to rotate by the linking member 140. In addition, the linking member 140 of the present disclosure is not limited thereto, any component that may make the linkage 120 and the fastener 130 rotate synchronously is acceptable.

In addition, the locking mechanism 100 further includes a latch 160 and a preloading element 170. In some embodiments, the connecting rod 120 has a first end 121 and a second end 122 that are opposite each other. The first end 121 may be connected to the first gear 141, and the second end 122 may be connected to the latch 160. The latch 160 may be used to operate the locking mechanism 100 (for example, to rotate the connecting rod 120), which may improve the convenience of operating the locking mechanism 100. In the present embodiment, the preloading element 170 may support the locking mechanism 100 when the locking mechanism 100 is not locked. More specifically, the preloading element 170 may be connected to the connecting rod 120 (for example, disposed at the second end 122 of the connecting rod 120), and may apply force to the connecting rod 120 to position the locking mechanism 100 at a specific position. Although the preloading element 170 is shown as a spring in this embodiment, the present disclosure is not limited thereto. Any element that may apply force to the connecting rod 120 to position the locking mechanism 100 is acceptable. For example, the preloading element 170 may also be a hydraulic element or any other suitable extendable element.

In some embodiments, a plurality of positioning portions 153 may be disposed in the annular sidewall 152 of the frame 150. The positioning portions 153 may be arranged along the inner edge of the annular sidewall 152 and suitable for positioning the connecting rod 120 and stably setting the connecting rod 120 in the frame 150. For example, after the connecting rod 120 is assembled into the frame 150, the positioning portions 153 may abut the connecting rod 120. Although a specific number of positioning portions 153 is illustrated in this embodiment, it merely serves as an example. Those skilled in the art may adjust the number and positions of positioning portions 153 based on the content of the present disclosure.

In addition, the frame 150 may has a first section 155 and a second section 156. In some embodiments, the main surfaces of the first section 155 and the second section 156 may be substantially perpendicular to each other. For example, the main surface of the first section 155 may be substantially parallel to the X-Z plane, and the main surface of the second section 156 may be substantially parallel to the X-Y plane, but the present disclosure is not limited thereto. At least one first hole 155A may be formed on the first section 155. Similarly, at least one second hole 156A may also be formed on the second section 156. Fasteners (such as screws or any other suitable elements) may be disposed in the first hole 155A and the second hole 156A to affix to the expansion device 20. In some embodiments, the first section 155 and the second section 156 may be disposed corresponding to the expansion device 20 (for example, to be attached to different surfaces of the expansion device 20) to strengthen the fixation between the frame 150 and the expansion device 20. For example, the first section 155 may be attached to the side surface 23 of the expansion device 20, and the second section 156 may be attached to the top surface 21 of the expansion device 20, but the present disclosure is not limited thereto.

In some embodiments, the second gear 142 and the fastener 130 may be first assembled together from opposite sides of the base 110. Next, the first gear 141 and the connecting rod 120 (along with the latch 160 and the preloading element 170) are assembled to the base 110 on the side that is opposite the fastener 130. Subsequently, the above structure may be combined with the frame 150 so that the connecting rod 120 abuts against the positioning portions 153 of the frame 150, and the base 110 is also accommodated in the corresponding space in the frame 150, thus completing the assembly of the locking mechanism 100. Next, the locking mechanism 100 may be combined with the expansion device 20. It should be noted that the annular sidewall 152 and the positioning portions 153 of the frame 150 may be semicircular (for example, on the X-Y plane), so that the connecting rod 120 can be easily installed to the frame 150.

FIGS. 4 to 6 illustrate cross-sectional views of the locking mechanism 100 and the bottom plate 10 along the line A-A shown in FIG. 1 in accordance with some embodiments of the present disclosure. As shown in FIG. 4, before the locking mechanism 100 (such as the fastener 130) is combined with the bottom plate 10, the preloading element 170 that abuts against the positioning portion 153 may position the locking mechanism 100 at a predetermined position (such as making the base 110 abut against the upper surface of the space S). In other words, the force generated by the preloading element 170 may overcome the gravity of the locking mechanism 100 (except for the frame 150). As a result, when the locking mechanism 100 is not locked, the position of the fastener 130 may be accurately controlled, thereby helping to ensure the smoothness of the locking mechanism 100 during locking.

As shown in FIG. 4, the connecting rod 120 has a central axis C1, the fastener 130 has a central axis C2, and the central axis C1 of the connecting rod 120 may be offset from the central axis C2 of the fastener 130. In this way, the space over the fastener 130 may not be occupied, so that the locking mechanism 100 is suitable for the expansion device 20 of a specific size, which is beneficial to improve the design flexibility of the electronic apparatus 1. For example, with the above configuration, the expansion device 20 may be located directly above the base 110. In some embodiments, the central axes C1 and C2 may be substantially parallel to the Z axis. In some embodiments, the latch 160 may be lifted to facilitate the operation of the locking mechanism 100. When the user activates the locking mechanism 100 (that is, to lock the fastener 130 into the hole 16), the user may first apply a downward force along the arrow A to make the fastener 130 approach the hole 16.

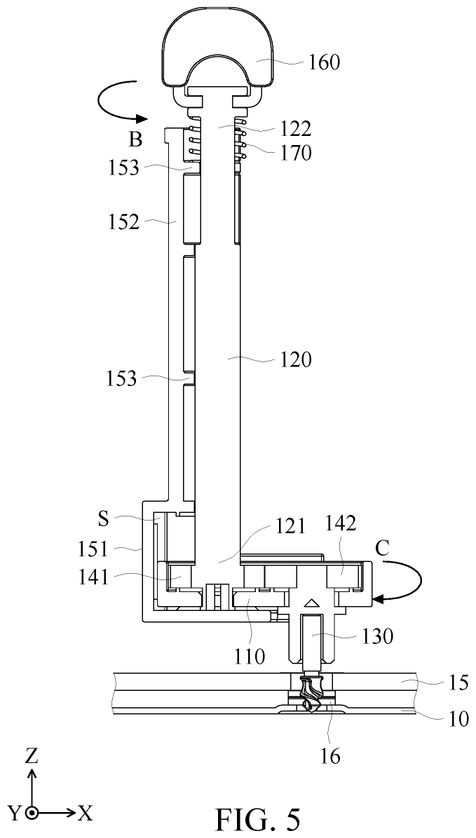

Next, as shown in FIG. 5, when the user applies a downward force, the preloading element 170 may be compressed and the base 110 also moves downward. After the base 110 moves downward to a position and abuts against the lower surface of the space S, the user may rotate the latch 160 in the direction of arrow B (for example, in a counterclockwise direction) to rotate the connecting rod 120. At this time, the linking member 140 would rotate with the connecting rod 120 to drive the fastener 130 to rotate in the direction of arrow C (for example, in a clockwise direction). More specifically, the first gear 141 of the linking member 140 may rotate in the direction of arrow B, driving the second gear 142 to rotate in the direction of arrow C. In this way, the fastener 130 may be screwed into the hole 16 to achieve the fixation. It should be noted that the operation mode (such as the rotation direction of the element) in this embodiment is merely an example, and those skilled in the art may adjust the operation mode of each element based on the content of the present disclosure.

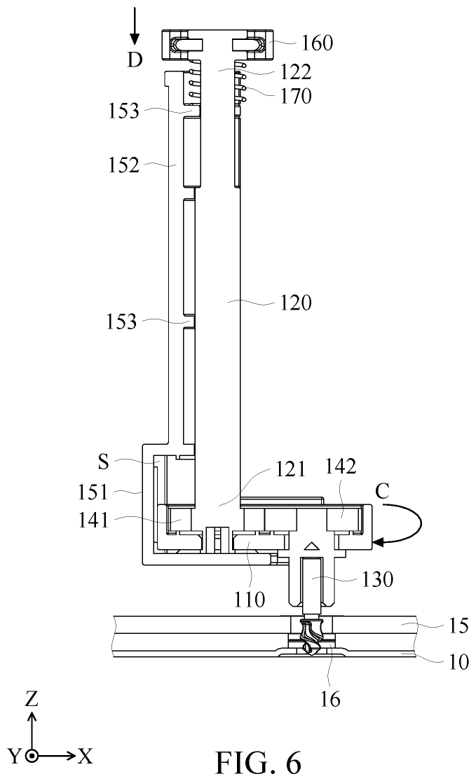

As shown in FIG. 6, after the fastener 130 is affixed in the hole 16, the latch 160 may be closed in the direction of the arrow D. As a result, the locking mechanism 100 does not protrude from the opening 22 of the expansion device 20 (as shown in FIGS. 1 and 2), thereby reducing the probability that the locking mechanism 100 interferes with the expansion device 20. Otherwise, when the user wants to release the locked state of the locking mechanism 100, the user may refer to the operations in the opposite manner to the processes shown in FIGS. 4 to 6, which will not be discussed in detail below.

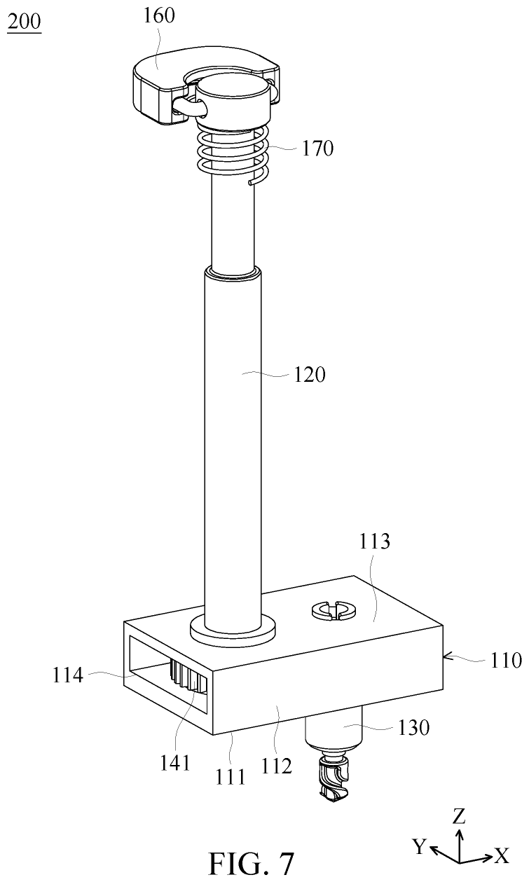

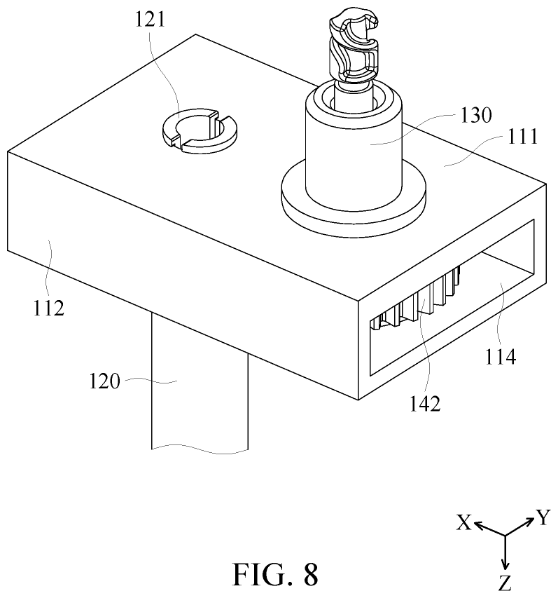

FIG. 7 illustrates a perspective view of a locking mechanism 200 in accordance with some embodiments of the present disclosure. FIG. 8 illustrates a partial enlarged perspective view of the locking mechanism 200 in accordance with some embodiments of the present disclosure. It should be understood that the locking mechanism 200 shown in this embodiment may include the same or similar elements or parts as the locking mechanism 100 shown in FIGS. 1 to 6. For the sake of brevity, these same or similar parts will be labeled with the same or similar numerals, and the related detailed descriptions may be omitted below. The difference between the locking mechanism 200 shown in this embodiment and the locking mechanism 100 shown in FIGS. 1 to 6 is that: in this embodiment, the base 110 of the locking mechanism 200 has a top surface 113 that is opposite the bottom surface 111. Openings 114 may be formed by the bottom surface 111, the sidewalls 112 and the top surface 113 on both sides of the base 110. In the present embodiment, the first gear 141 may be placed into the base 110 from the opening 114, and then the connecting rod 120 may be inserted through the base 110 to be combined with the first gear 141. Similarly, the second gear 141 may be placed into the base 110 from the other opening 114, and then the fastener 130 may be inserted through the base 110 to be combined with the second gear 142.

In addition, as shown in FIGS. 7 and 8, the connecting rod 120 and the fastener 130 may penetrate the bottom surface 111 and the top surface 113 of the base 110 at the same time. Since the connecting rod 120, the fastener 130 and the base 110 all have multiple contact points, the structure of the connecting rod 120 and the fastener 130 may be kept as upright as possible (for example, substantially parallel to the Z axis), thereby improving the accuracy of the operation of the locking mechanism 200, or reducing the probability that the fastener 130 of the locking mechanism 200 cannot be locked in the hole 16.

In summary, the present disclosure provides a locking mechanism and an electronic apparatus with a linkage member for linking up between a connecting rod and a fastener. By setting the linkage member to make the connecting rods and the fastener, whose central axes are offset from each other, move in conjunction, the locking mechanism may be suitable for the expansion device of a specific size, and the performance and design flexibility of the electronic apparatus may be improved. In addition, the connecting rod, the fastener and the base may have multiple contact points, so as to keep the structure of the connecting rod and the fastener as upright as possible, thereby improving the accuracy of operating the locking mechanism, or reducing the probability that the fastener of the locking mechanism cannot be locked in the hole of the electronic apparatus.

While the embodiments and the advantages of the present disclosure have been described above, it should be understood that those skilled in the art may make various changes, substitutions, and alterations to the present disclosure without departing from the spirit and scope of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. As long as those may perform substantially the same function in the aforementioned embodiments and obtain substantially the same result, they may be used in accordance with some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. A locking mechanism, comprising:
a base;
a connecting rod penetrating the base and rotatable relative to the base;
a fastener penetrating the base and rotatable relative to the base, wherein the connecting rod is disposed parallel to the fastener; and
a linking member connected to, and configured to link up with, the connecting rod and the fastener.

2. The locking mechanism as claimed in claim 1, further comprising a latch rotatable relative to the connecting rod, wherein the connecting rod has a first end and a second end opposite the first end, the first end is connected to the linking member, and the second end is connected to the latch.

3. The locking mechanism as claimed in claim 1, wherein the linking member comprises a plurality of gears engaged with each other, one of the gears is disposed around the connecting rod, and another of the gears is disposed around the fastener.

4. The locking mechanism as claimed in claim 3, wherein a rotation direction of the connecting rod is different from a rotation direction of the fastener.

5. The locking mechanism as claimed in claim 1, further comprising a frame disposed around the base and the connecting rod.

6. The locking mechanism as claimed in claim 5, wherein the frame has a plurality of positioning portions disposed to abut the connecting rod.

7. The locking mechanism as claimed in claim 6, further comprising a preloading element connected to the connecting rod and abutting one of the positioning portions.

8. The locking mechanism as claimed in claim 7, wherein the preloading element is a spring.

9. The locking mechanism as claimed in claim 1, wherein the base has a top surface and a bottom surface opposite the top surface, and the connecting rod and the fastener penetrate the top surface and the bottom surface.

10. The locking mechanism as claimed in claim 1, wherein a central axis of the connection is offset from a central axis of the fastener.

11. An electronic apparatus, comprising:
a bottom plate;
an expansion device disposed on the bottom plate; and
a locking mechanism configured to affix the expansion device onto the bottom plate and comprising:
a base;
a connecting rod penetrating the base and rotatable relative to the base;
a fastener penetrating the base and rotatable relative to the base, wherein the connecting rod is disposed parallel to the fastener; and
a linking member connected to, and configured to link up with, the connecting rod and the fastener.

12. The electronic apparatus as claimed in claim 11, further comprising a plurality of electronic components connected to the expansion device.

13. The electronic apparatus as claimed in claim 11, wherein the expansion device has a top surface and an opening formed on the top surface, and part of the locking mechanism is exposed from the opening.

14. The electronic apparatus as claimed in claim 11, wherein the expansion device is located over the base.

15. The electronic apparatus as claimed in claim 11, wherein a hole is disposed on the bottom plate and configured to bond with the fastener.

16. The electronic apparatus as claimed in claim 11, wherein the locking mechanism further comprises a frame disposed around the base and the connecting rod.

17. The electronic apparatus as claimed in claim 16, wherein the frame has a first section and a second section, and the first section and the second section are substantially perpendicular to each other and attached to different surfaces of the expansion device.

18. The electronic apparatus as claimed in claim 11, wherein the linking member comprises a plurality of gears engaged with each other, one of the gears is disposed around the connecting rod, and another of the gears is disposed around the fastener.

19. The electronic apparatus as claimed in claim 11, wherein a central axis of the connection is offset from a central axis of the fastener.

20. The electronic apparatus as claimed in claim 11, wherein the base has a top surface and a bottom surface opposite the top surface, and the connecting rod and the fastener penetrate the top surface and the bottom surface.
